(19) United States
(12) Patent Application Publication
(10) Pub. No.: US 2011/0064393 A1
(43) Pub. Date: Mar. 17, 2011

(54) OVEN

(75) Inventors: Robert Kenneth Yasuji Fletcher, Racine, WI (US); Jeffrey L. Spenner, Milwaukee, WI (US)

(73) Assignee: PHOENIX PRODUCTS COMPANY, INC., Milwaukee, WI (US)

(21) Appl. No.: 12/879,337

(22) Filed: Sep. 10, 2010

Related U.S. Application Data
(60) Provisional application No. 61/242,174, filed on Sep. 14, 2009.

(51) Int. Cl. F27D 11/12; A21B 1/00

(52) U.S. Cl. 392/416; 219/391; 219/399

(57) ABSTRACT

An oven is provided for re-baking welding consumables in an efficient and improved heat distribution manner. The oven includes a first chamber having a plurality of first chamber vents positioned on at least one sidewall of the first chamber and a heating source in a second chamber, the second chamber being in fluid communication with the first chamber, and one or more third chambers situated on a sidewall of the first chamber, wherein heat energy from the heating source flows through the third chamber into the first chamber, and wherein the heat energy from the heating source is substantially and evenly distributed inside the first chamber.

### CROSS-REFERENCE TO RELATED APPLICATIONS

This application claims the benefit of U.S. provisional patent application No. 61/242,174 entitled “Oven” and filed on Sep. 14, 2009, which is hereby incorporated by reference herein.

### FIELD OF THE INVENTION

The present invention relates generally to industrial ovens. More particularly, the present invention relates generally to welding consumable re-baking ovens.

### BACKGROUND OF THE INVENTION

Welding consumables, such as electrodes and flux, are integral components when joining steel and alloy steels. With the increased need for higher strength steel and steel alloy, there is a need for specialized welding consumables. Welding electrodes that have been exposed to the atmosphere for extended periods of time negatively affect weld quality, therefore there is a need to recondition or re-bake welding consumables to remove excess moisture from the electrodes. Excess moisture in electrodes increases the propensity for hydrogen in the weld, which can often cause cracking and premature failure of a weld. Due to the increased need for specialized welding consumables, it is critical to properly re-bake electrodes.

Re-baking ovens use significantly large amounts of energy to maintain high temperatures adequate for proper re-baking. These ovens typically require a duty-cycle in the 30% to 50% range. Further, these ovens are subject to re-baked product quality consistency issues as a result of non-uniform temperatures inside the oven and insufficient positioning of the products during the re-baking process.

It would be advantageous to have a re-baking oven that is efficient and reduces the amount of operating energy. It would be a further advantage to have a re-baking oven that distributes heat energy evenly throughout a heating chamber to improve quality consistency among the products re-baked in the oven.

### SUMMARY OF THE INVENTION

In accordance with at least one embodiment, an oven is provided with a heating element within a heating element chamber having a plurality of chamber vents. The oven also includes a heating chamber for re-baking welding consumables, and a plurality of vent chambers in fluid communication with the heating element chamber and heating chamber.

In accordance with another embodiment, a welding consumable re-baking oven is provided with a first chamber having a plurality of first chamber vents positioned on at least one sidewall of the first chamber, a heating source in a second chamber, the second chamber being in fluid communication with the first chamber. The oven further includes one or more third chambers situated on a sidewall of the first chamber, wherein heat energy from the heating source flows through the third chamber into the first chamber, and wherein the heat energy from the heating source is substantially and evenly distributed inside the first chamber.

In accordance with yet another embodiment, a method for re-baking a welding consumable is provided, the method including placing a welding consumable within a first chamber, activating a control unit configured for maintaining a temperature range in the oven by cycling a heat source, and radiating heat energy from the heat source situated in a second chamber. The method further includes directing the radiated heat energy through a plurality of first passages in the sidewall of the second chamber, communicating the radiated heat energy upwards from the first passages into second passages situated in the sidewall of the first chamber, and substantially uniformly distributing the heat energy from the second chamber and second passages into the first chamber. The method in another embodiment further including cycling the heat source with about a ten-percent duty-cycle.

Other embodiments, aspects, features, objectives and advantages of the present invention will be understood and appreciated upon a full reading of the detailed description and the claims that follow.

### BRIEF DESCRIPTION OF THE DRAWINGS

Embodiments are disclosed with reference to the accompanying drawings and are for illustrative purposes only. The embodiments are not limited in their application to the details of construction or the arrangement of the components illustrated in the drawings. Rather, the embodiments are capable of being varied or of being practiced or carried out in other various ways. The drawings illustrate a best mode presently contemplated for carrying out one embodiment. In the drawings:

FIG. 1 is a perspective view of an exemplary oven;

FIG. 2 is a front view of the oven of FIG. 1 in accordance with at least one embodiment;

FIG. 3 is a front view of the oven in FIG. 2, with the oven door open;

FIG. 4 is a cross-sectional side view along lines 4-4 of the oven in FIG. 2;

FIG. 5 is a cross-sectional front view along lines 5-5 of the oven in FIG. 4;

FIG. 6 is a perspective view of a heating rack for the oven in FIG. 1, in accordance with at least one embodiment; and

FIGS. 7A and 7B are side cross-sectional views of alternative heating chamber vent configurations in accordance with at least one embodiment.

### DETAILED DESCRIPTION OF THE PREFERRED EMBODIMENT

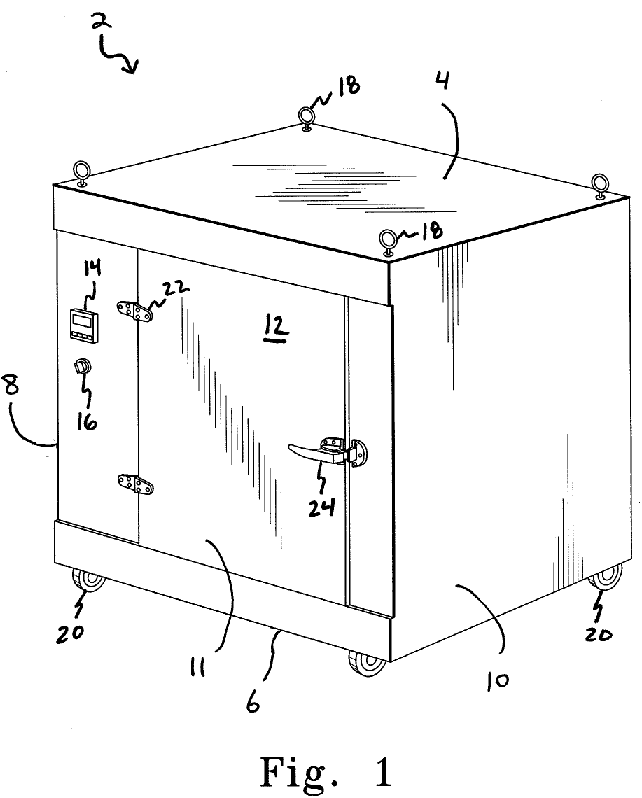

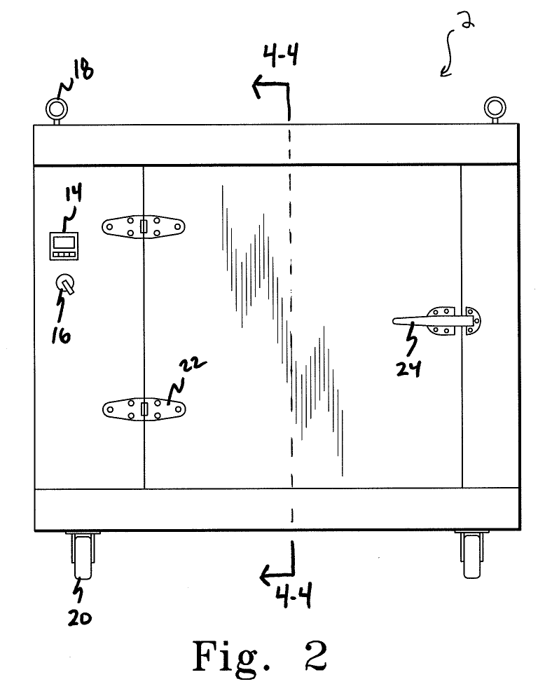

An exemplary re-baking oven 2 is provided in FIGS. 1-2. The oven 2 is generally a cuboidal structure, such as a rectangle, although in some embodiments the oven 2 can include other shapes. The oven 2 includes a top 4, a bottom 6, a left side 8, a right side 10, and a front 11. The front 11 includes a door 12, a control unit 14, and a power switch 16. The top includes a set of hoisting eyelets 18 and the bottom includes a set of wheels 20. The door 12 is operably connected to the oven 2 through a set of two hinges 22 secured to the front 11 and a mechanical handle latch 24. In one embodiment the oven includes a set of four eyelets 18 and a set of four wheels 20, although in other embodiments the eyelets and/or the wheels can be omitted.

The control unit 14 is a typical oven controller, such as the exemplary unit identified below that provides user operational control of the oven 2 such as, allowing a user to turn the oven on or off and to vary the target temperature within the oven. In addition, temperature information and heating element status are provided by the control unit 14. An exemplary control unit 14 includes a Love model 16B PID controller as manufactured by Dwyer Industries Inc. (Michigan City, Ind.). The power switch 16 serves as a master On/Off switch. An exemplary power switch 16 is a Part # A22SC2M02 Double Pole On/off Power switch as manufactured by OMRON Corporation (Kyoto, Japan).

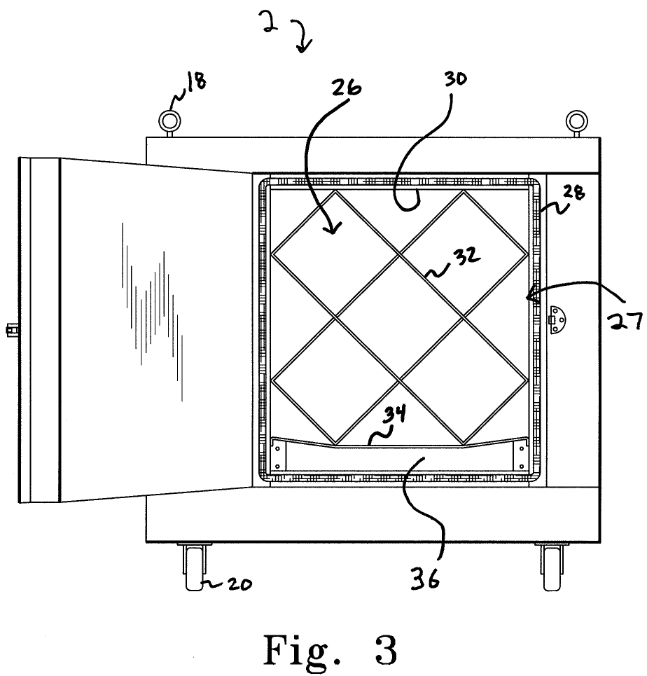

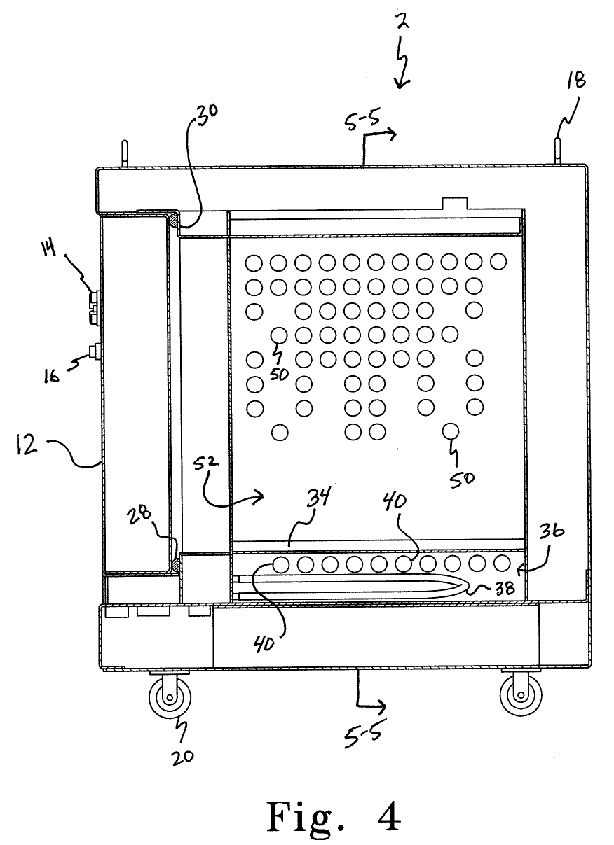

Referring to FIG. 3, a front view of the oven 2 is provided with the door 12 in an open position exposing the oven interior 27. The oven interior 27 includes a heating chamber 26 for heating a product and an element chamber 36 for providing heat energy for use by the heating chamber 26. The heat energy can be provided by one of numerous types of sources, such as one or more electric heating elements 38 (FIG. 4). Oven 2 includes an insulating material 28 situated on at least one of a doorframe 30 or on the door 12 that serves to maintain the heat energy inside the heating chamber 26 about the door opening. A removable rack 32 can be provided within the heating chamber 26 for stacking products, such as welding consumables, during the re-baking process. In at least one embodiment, the rack 32 is configured to extend substantially to the extents of the heating chamber 26 to optimize the space. In another embodiment the rack 32 is omitted. The rack 32 can rest on a bottom portion 34 of the heating chamber 26 or be supported at another location in the heating chamber, such as the sidewalls 41, 43. The bottom portion 34 functions as the top of the element chamber 36. The heat energy provided by the elements 38 increases the temperature of the medium, such as air, gas or liquid, within the element chamber 36. The heat energy (e.g., heated gas) is in fluid communication with the heating chamber 26 and travels from the element chamber 36, through vent chambers 46, 48 and into the heating chamber 26, as discussed below.

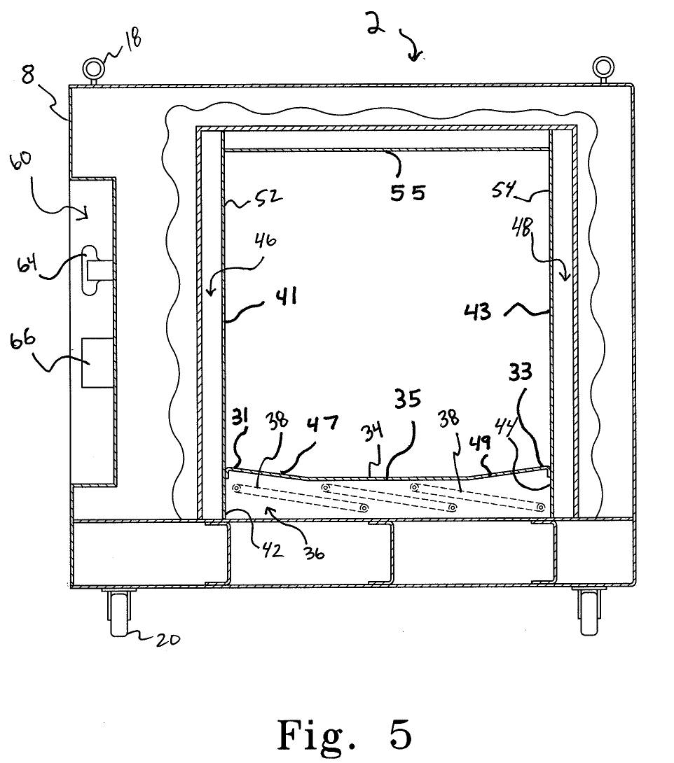

Referring to FIG. 4, a cross sectional view of the oven 2 along lines 4-4 is provided. The heating elements 38 are shown positioned within the element chamber 36. In at least one embodiment, heating elements 38 include 3 resistive 1500 Watts heating elements in a 3-phase delta configuration (see FIG. 5) for a total of 4500 Watts. An oven with this heating element configuration has a temperature range from ambient temperature to about 800 degrees Fahrenheit. In another embodiment, a single resistive heating element can be provided that generates greater than 1500 Watts. In another embodiment, one or more suitable heating elements, as known in the art, can be provided to generate an oven temperature range that exceeds 800 degrees Fahrenheit.

Referring now to FIGS. 4-5, in at least one embodiment, the element chamber 36 and the heating chamber 26 include sidewalls 41, 43 on left and right sides, respectively, the sidewalls include sidewall lower portions 42, 44, situated in the element chamber 36, and sidewall upper portions 52, 54, situated in the heating chamber 26. At least one of the sidewall lower portions 42, 44 includes a plurality of element vents 40 which form passages through the sidewall lower portions 42, 44. The element vents 40 serve to provide communication between the element chamber 36 and one or more vent chambers 46, 48 that extend substantially vertically along the sidewalls 41, 43. The plurality of heating chamber vents 50 are positioned along one or more sidewall upper portions 52, 54. The heating chamber vents 50 form a plurality of passages that provide communication between the heating chamber 26 and the vent chambers 46, 48. In operation, heat energy is generated in the element chamber 36 and is passed through the element vents 40 into the vent chambers 46, 48 where it travels upwards and through the heating chamber vents 50 into the heating chamber 26.

To provide uniform heating in the heating chamber 26, both natural and guided convection currents are utilized, at least in part, by configuring ends 31, 33, of the bottom portion 34 to raise upward slightly as they extend a distance from a center point 35 and towards the sidewalls 41, 43 to form sloped surfaces 47, 49 as seen in FIG. 5. Since the bottom portion 34 also acts as the ceiling for the element chamber 36, the sloped surfaces 47, 49 help guide the heated air from the element chamber 36 in the direction of the element vents 40. In one embodiment, the sloped surfaces 47, 49 can be modified by increasing or decreasing the slope angle from what is provided in FIG. 5. In another embodiment, the bottom portion 34 can begin sloping up towards the sidewall lower portions 42, 44 from the center point 35.

After passing through the element vents 40, the rising heat energy naturally rises in the vent chambers 46, 48. The heated energy is then guided into the heating chamber 26 by the positioning of the heating chamber vents 50. Since the heating element 38 is close to the bottom portion 34, this portion of the heating chamber 26 will be naturally heated. However, as the distance from the heating element 38 increases inside the heating chamber 26, the more guidance the heating energy requires to provide a substantially uniform temperature inside the oven 2. To accomplish such guidance, an increasing proportional number of heating chamber vents 50 are provided moving from adjacent the bottom portion 34 upwards toward a top 55 of the heating chamber 26. The increasing proportion of heating chamber vents 50 allow for more heat energy to flow into the heating chamber 26 to compensate for the distance from the heating element. In at least some embodiments, the proportion can decrease prior to increasing.

In at least one embodiment, the heating chamber vents 50 and element vents 40 are generally circular in shape, having a diameter of about 1 inch. In another embodiment, the heating chamber vents 50 and element vents 40 can range from about 1 centimeter in diameter to about 2 inches or greater in diameter. In other embodiments, the heating chamber vents 50 and element vents 40 can be further varied in size to accommodate various oven requirements. The heating chamber vents 50 and element vents 40 can be identical or different, and can include a variety of one or more shapes, including various sided polygons, and a variety of sizes as desired to accommodate various oven requirements.

Referring to FIG. 5, the oven 2 includes a recess 60 located on the left side 8. The recess 60 includes various typical oven electrical components for facilitating the operation of the oven, including a transformer 64 and a relay contactor 66. These and other typical electrical components (not shown) are selectively positioned distal to the heating element 38. Additionally, insulation (not shown) is located between the heating chamber 26 and the external walls of the oven, thereby inhibiting heat energy from exiting the heating chamber 26.

The oven 2 configuration as described above provides an efficient generation of high re-baking temperatures. By example, the duty-cycle of the oven 2 can be lower than the typical value for a conventional oven, for example, in at least one embodiment, the duty-cycle can average about 10%-35%. In another embodiment, the duty-cycle can average about 10%-25%. In still another embodiment, the duty-cycle can average less than 30%. In yet another embodiment, the duty-cycle can average about 10%. The reduced duty-cycle results in a significant energy savings and reduced cost as compared to ovens in the prior art, for example, the oven 2 in one embodiment can consume from about 30% to about 50% less power than typical re-baking ovens. Furthermore, the placement of the heating chamber vents 50 enables substantially uniform heat distribution within the heating chamber 26, which provides for the uniform re-baking of products, which in turn can provide increased performance of the products. By example, the re-baking of welding consumables with the oven 2 translates into increased weld performance based upon the higher quality electrodes produced by the re-baking process. Comparative testing has shown that when the oven 2 is used for the re-baking of electrodes, the oven 2 provides higher quality electrodes (e.g., more uniform evaporation of moisture) and requires significantly less energy (e.g., reduced duty-cycle) than previously known re-baking ovens.

An exemplary heating process for re-baking welding consumables using oven 2 includes several steps. The welding consumable is placed on the rack 32 within the heating chamber 26. The oven 2 is activated by using the power switch 16 to power-on the oven for control, and setting the control unit 14 to select a heating temperature and re-baking time. The temperature and re-baking time are based at least in part upon the material properties of the consumable being re-baked. The control unit 14 activates the heating element 38 generating heat energy within the element chamber 36. Heat energy in the element chamber 36 radiates outwards and upwards towards the bottom portion 34 (ceiling of the element chamber) and is at least partially directed away from the center point 35 and towards sidewall lower portions 42, 44, and subsequently is pushed through the element vents 40 into the vent chambers 46, 48. Heating energy then proceeds upwards along the vent chambers 46, 48 and migrates through the heating chamber vents 50 into the heating chamber 26. Heating energy that enters the heating chamber 26 surrounds the rack 32 and the consumable situated on the rack 32. The control unit maintains a desired temperature range and the products are re-baked for a desired amount of time.

Once the re-baking process is complete, the consumables can be removed. Alternatively, the oven 2 can be used as a holding oven. While functioning as a holding oven, the heating chamber 26 is maintained at a temperature about equal to or less than that used during the re-baking process. Alternatively, welding consumables can be placed in the oven 2 after having been re-baked in a separate oven. In this case, the oven functions only as a holding oven. Welding consumables remain in the oven 2 in order to avoid extended exposure to the atmosphere where they can absorb moisture from the atmosphere.

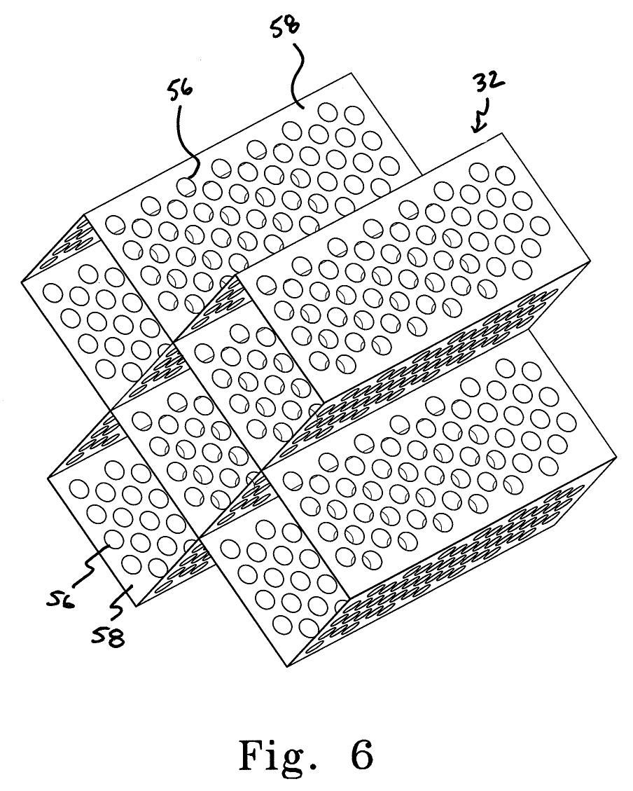

Referring now to FIG. 6, an exemplary removable rack 32 is shown. The rack 32 includes a plurality of surfaces 58 for positioning products inside the oven 2. Each of the surfaces 58 include a plurality of heat distribution passages 56 for assisting with the uniform distribution of heat energy inside the oven 2. Although the rack 32 is shown in FIG. 6 with the surfaces 58 forming a criss-cross (e.g., diamond) configuration, the shape and orientation of the surfaces 58 can vary to accommodate various products being placed inside the oven 2. In addition, the heat distribution passages 56 can vary in size and shape, or not be included at all. In one embodiment, the load capacity of the oven 2 with the rack 32 is about 400 lbs. In another embodiment, by varying the size of the oven 2 and the configuration of the rack 32, the load capacity of the oven 2 can range from about zero to about 1000 lbs or greater.

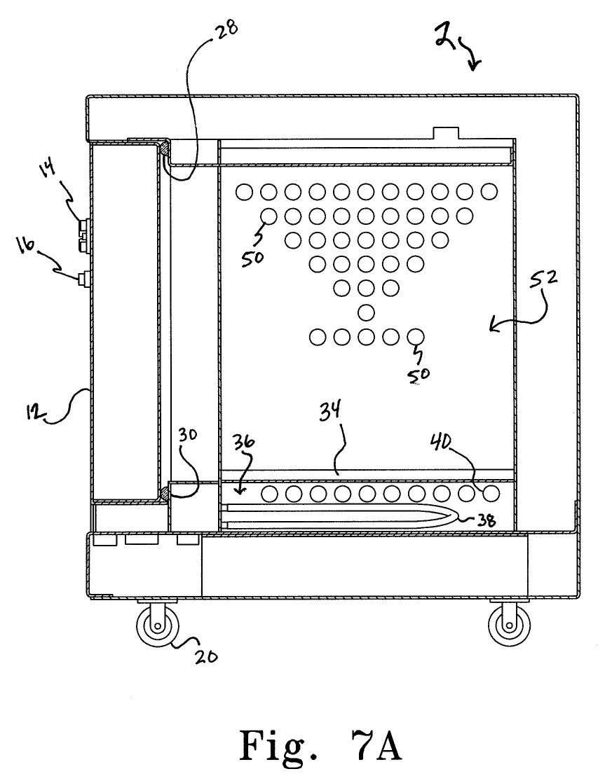

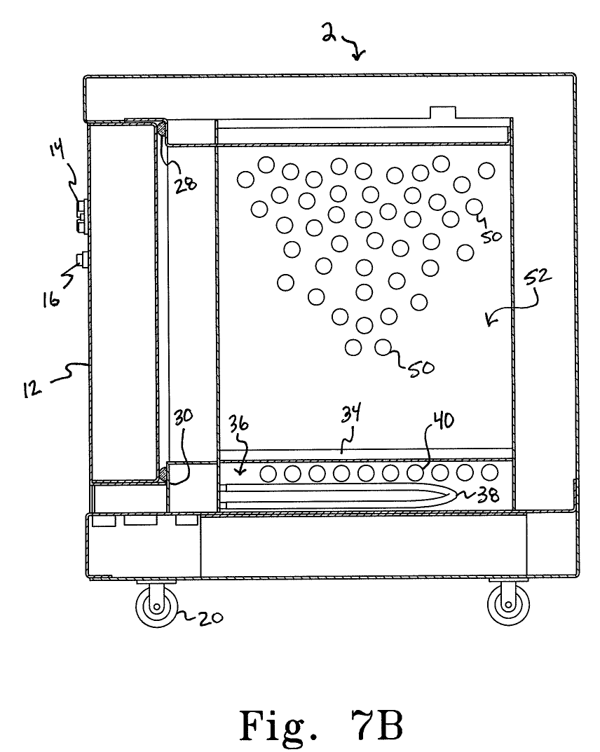

Referring to FIGS. 7A and 7B, alternative heating chamber vent 50 configurations are provided. The configuration in FIG. 7A generally has an upside-down triangle shape, which allows for a greater proportion of heating chamber vents 50 situated away from the bottom surface 34. The configuration in FIG. 7B is a randomized pattern with a greater proportion of heating chamber vents 50 situated away from the bottom surface 34. Both sidewalls 41, 43 for the ovens shown in FIGS. 7A and 7B can include heating chamber vents 50.

It is specifically intended that the aforementioned embodiments and illustrations not be limited as shown and described herein, but rather also include modified forms of those embodiments including portions of the embodiments and combinations of elements of different embodiments as come within the scope of the following claims.

We claim:

1. An oven comprising:
An element chamber having a plurality of element vents;
a heating source situated within the element chamber;
a heating chamber for receiving materials to be re-baked, wherein the heating chamber includes a plurality of heating chamber vents; and
a plurality of vent chambers in fluid communication with the element chamber and heating chamber.

2. The oven according to claim 1 further comprising a rack.

3. The oven according to claim 2, wherein the rack is a welding consumable rack having a plurality of heat distribution passages.

4. The oven according to claim 3, wherein the welding consumables include electrodes.

5. The oven according to claim 1, wherein the materials include welding consumables.

6. The oven of claim 5, wherein the vent chambers extend substantially vertically and are positioned along one or more sidewalls of the heating chamber and element chamber.

7. The oven according to claim 6, wherein the element vents are located on at least two sidewalls of the element chamber and the heating chamber vents are positioned along the same sidewalls in the heating chamber.

8. The oven according to claim 7, wherein the heating chamber vents are distributed such that there is an increasing proportion of chamber vents proximal to a top portion of the heating chamber relative to a bottom portion of the heating chamber.

9. The oven according to claim 8, wherein the element chamber includes a ceiling having at least one sloped surface that extends to about one of the ends of the ceiling, wherein the sloped surface is directed upwards as the ceiling extends from a distance about a center point of the ceiling towards at least one sidewall of the element chamber.

10. The oven according to claim 9, wherein at least two sloped surfaces are provided extending towards opposite sidewalls of the element chamber.

11. The oven according to claim 8, wherein a substantially uniform distribution of heat energy is provided within the heating chamber.

12. The oven according to claim 11, further comprising a rack.

13. The oven according to claim 12, wherein the rack is a welding consumable rack that includes a plurality of heat distribution passages.

14. The oven according to claim 13, wherein the heat distribution passages are evenly distributed on each surface of the rack.

15. The oven according to claim 14, wherein the heat source is at least one electric element operated by a controller unit.

16. The oven according to claim 15, wherein the heating chamber vents are about 1 centimeter to about 2 inches in diameter.

17. The oven according to claim 8, wherein the heat source is at least one electric element that is cycled on and off with a duty-cycle of about ten-percent to about twenty-five percent.

18. A welding consumable re-baking oven comprising:
a first chamber having a plurality of first chamber vents positioned on at least one sidewall of the first chamber;
a heating source in a second chamber, the second chamber being in fluid communication with the first chamber; and
one or more third chambers situated about a sidewall of the first chamber, wherein heat energy from the heating source flows through the third chamber into the first chamber, and wherein the heat energy from the heating source is substantially and evenly distributed inside the first chamber.

19. A method for re-baking a welding consumable, comprising the steps of:
placing a welding consumable within a first chamber;
activating a control unit configured for maintaining a temperature range in the oven by cycling a heat energy source;
radiating heat energy from the heat source situated in a second chamber;
directing the radiated heat energy through a plurality of first passages in the sidewall of the second chamber;
communicating the radiated heat energy upwards from the first passages into second passages situated in the sidewall of the first chamber; and
distributing the heat energy from the second chamber and second passages into the first chamber to provide a substantially uniform distribution of heat energy in the first chamber.

20. The method for re-baking according to claim 19, further including cycling the heat source at about a ten-percent to twenty-five percent duty-cycle.
